(19) United States
(12) Patent Application Publication
(10) Pub. No.: US 2006/0221865 A1
(43) Pub. Date: Oct. 5, 2006

(54) Method and system for autonomous link discovery and network management connectivity of remote access devices

(75) Inventors: Jeff Hawbaker, Naperville, IL (US); Wendy Teller, Naperville, IL (US); Jon Sadler, Naperville, IL (US); Thomas T. Rarick, Wheaton, IL (US); John Sauer, Naperville, IL (US); Kevin Stodola, Naperville, IL (US); Steve Schwager, Lisle, IL (US); Dale Scholtens, Lisle, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 11/093,738

(22) Filed: Mar. 30, 2005

(51) Int. Cl. H04L 12/28

(52) U.S. Cl. 370/255; 370/352

(57) ABSTRACT

Autonomous link discovery specifies a method and associated procedures that automatically discover various levels of transmission links and paths between transport network elements residing in the transport plane of communications networks. Unlike more traditional centralized polling techniques rooted in a management plane, autonomous link discovery procedures are rooted in and triggered by network elements composing the transport plane. As such, autonomous link discovery procedures may be event driven and execute in a coordinated, distributed fashion to automatically detect new link connectivity associations and correlate link endpoint attributes between these network elements. Once successful link correlations have been determined, autonomous notifications of these correlated link associations are sent to management elements and/or control elements residing in their respective management and control plane domains.

### BACKGROUND OF THE INVENTION

Communications networks generally comprise two or more nodes, such as a computer or a router, connected together by a series of communications links and network elements which themselves may be connected in a variety of ways, including via electrical and fiber-optic cables. A cable carries one or more connections, or communications links, between two adjacent network elements, and a network path within a network is defined by a connection between two end nodes. Network elements located along the network path between the two end nodes provide the interconnection of individual connection segments, the sum of which compose the entire end to end connection between end nodes.

Once established, transport network topologies have traditionally been static and seldom changing. This semi-permanence arises from a number of factors. From an operations aspect, the provisioning of transport lines and paths and supporting databases have traditionally been triggered from a centralized network management framework using centralized polling techniques. These centralized operations approaches add complexity in that these network management platforms must contain knowledge of network topologies across differing layers of the transport hierarchy. Modifications to existing topologies require much analysis, planning and possibly changes to the management platforms themselves, adding even more complexity. This all results in additional time and effort, contributing further to the static nature of transport networks.

For example, equipment orders are placed and deployed based on network engineering planning functions and the resulting provisioning of the management systems' logical view of engineered network topology. Traditionally, once their supporting transport facilities are physically equipped (or even before becoming equipped), transport lines and paths are provisioned and placed in-service via management elements (i.e., Element Management Systems/Network Management Systems) residing in the management plane. As a drawback, this static provisioning approach offers up the possibility of the management plane's topological viewpoint of these transport resources becoming misaligned with the actual connectivity of these same transport resources in the transport plane. This viewpoint may result in “orphaned” equipment deployed to the field that may not be used or may be underutilized in actual link connectivity.

In terms of physical connectivity, transport lines and paths have traditionally been connected on a semi-permanent basis either directly between transport/switching nodes or through cross connect and multiplexing platforms. In the latter case, this connectivity has been directed via traditional operations procedures rooted in the management plane.

Management and control plane domains may encompass one or more hierarchical layers of the transport plane. A control channel is a logical channel that carries network information rather than the actual data messages transmitted over the network. Connections created by management/control plane actions within a serving transport layer (e.g., the Optical Carrier level-n (OC-n) line layer) may in fact be advertised and used as links for a client transport layer (e.g., the Synchronous Transport Signal (STS) path layer).

Typically, relationships between management and control actions directing connectivity within and between transport layers must interoperate with a fairly high degree of coordination and synchronization. This tends to introduce a fair degree of dependence and coupling in the sequencing and execution of management and control actions pursuant to connection establishment and verification functions. The coordination of these actions is typically dependent on the proper deployment of equipment and personnel encompassing the correct skill sets, to the proper locations, in the same timeframes. The failure in any of these regards represents a weakest link scenario with a high likelihood of wasted time and resources, additional costs, and longer service activation times.

Adding even more complexity are network service providers' requirements in the form of multi-vendor interoperability. New service deployments requiring the involvement of and interaction between multiple layers of the transport hierarchy typically dictate the requirement for interoperability between multiple vendors' implementations of their respective elements of transport, management, and control planes. These requirements may dictate interoperability of multiple vendors' management and/or transport planes either within the same layer (intra-layer interoperability) or between layers (inter-layer interoperability) of the transport hierarchy. With the introduction of additional transport layers (e.g., the photonic layer) and associated management plane(s), along with the dynamics introduced by control plane capabilities, the complexities of multi-vendor interoperability are magnified even further. Aside from the technological interoperability complexities, the alignment of product releases across multiple vendors' product roadmaps creates additional complications. Again, these complexities translate to additional time and resource commitments, adding even more to the stratification of transport networks, which weighs into longer deployment times of new offerings from network service providers.

### SUMMARY OF THE INVENTION

The introduction of a number of technologies, such as Wavelength Division Multiplexing (WDM), optical switches, mesh restoration, and control planes, have tended to skew transport network topologies towards the more dynamic end of the spectrum. This paradigm shift has tended to magnify and raise in importance a number of issues that have not been as critical in the more traditional, static approaches to transport networking. Aspects of the present invention renders assistance to the control and management planes in support of improved robustness, autonomy, and performance requirements dictated by the new transport networking dynamics.

One embodiment of the present invention provides a method and system for automatically discovering transmission links and network paths among network elements in a communications network by detecting and validating proper connectivity between communications ports residing on network elements. This embodiment uses in-band communications in the communications network, initiated by the network elements; along with the correlation of link related attributes of the communications ports to automatically discover and validate physical connectivity between the network elements. Once physical connectivity is thus discovered via network elements within the transport plane, further correlation and validation of link related attributes and supporting databases can be initiated and carried out in either the control plane or the management plane. The method and system may also include the establishment of control channel adjacencies, also initiated from either the control plane or the management plane. By using these methods, a network service provider can update databases and manage network connectivity for its customers.

Another embodiment of the present invention provides a method and system for establishing control channel adjacencies, or management connectivity in a network, by sending an in-band signal from a network element over a network path using dedicated communications overhead of the network path. The signal contains an initiation message that indicates a unique identifier of the originating network element. A management element receives the signal and processes the initiation message to make a connectivity determination to the originating network element. Based on the connectivity determination, a connection between the management element and the remote access device is established.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates an exemplary network topology employing the autonomous link discovery of the present invention;

FIG. 2 illustrates steps to a successful completion of the port identification procedures between network elements in the network topology of FIG. 1;

FIG. 3 illustrates port identification procedures responsive to a bi-directional mismatch between network elements in the network topology of FIG. 1;

FIG. 4 illustrates port identification procedures responsive to a remote port identity mismatch between network elements in the network topology of FIG. 1;

FIG. 5 illustrates a successful control plane initiated link discovery procedure performed after the successful completion of port identification procedures as in FIG. 2;

FIG. 6 illustrates a link discovery procedure performed after the successful completion of port identification procedures as in FIG. 2, and responsive to a transport attribute mismatch;

FIG. 7 illustrates a link discovery procedure performed after the successful completion of port identification procedures as in FIG. 2, and responsive to a control attribute mismatch;

FIG. 8 illustrates a successful management plane initiated link discovery performed after the successful completion of port identification procedures as in FIG. 2;

FIG. 9 illustrates a control plane initiated control adjacency procedure performed prior to link discovery procedure as in FIG. 5;

FIG. 10 illustrates a management plane initiated control adjacency procedure performed after a link discovery procedure as in FIG. 8; and

FIG. 11 illustrates the use of an initiation message containing a unique identifier in a signal overhead in a control adjacency procedure in an embodiment of the present invention.

### DETAILED DESCRIPTION OF THE INVENTION

A description of preferred embodiments of the invention follows.

The principles of the present invention enable automatic discovery of various levels of transmission links and paths between network elements in communication networks by employing two procedures: port identification and link correlation. In some circumstances, a third procedure, referred to as control adjacency, may also be employed. Each of these three procedures is discussed in detail below.

Embodiments of the present invention render assistance in the de-coupling of management plane and control plane actions pursuant to the management and control of client/serving transport layers. They allow for the autonomous discovery of new links within a serving transport layer that can then be offered up to a client transport layer for advertisement there. As an example, when an Optical Carrier-level n (OC-n) link is completed between two network elements by virtue of connection across an optical fiber switching node, that OC-n link will be discovered via automated link discovery procedures which in turn provide notification of that link's existence to an Automatically Switched Optical Network/Generalized Multi Protocol Label Switching (ASON/GMPLS) based control plane. The control plane can then advertise this OC-n link thus enabling Synchronous Transport Signal (STS) connectivity across that OC-n link. That subsequent creation of these STS connections may in turn cause STS paths to be automatically discovered by other STS path terminating transport nodes so that these STS paths can in turn be advertised to the control plane thus enabling Virtual Tributary (VT) connectivity across any of these newly discovered STS links.

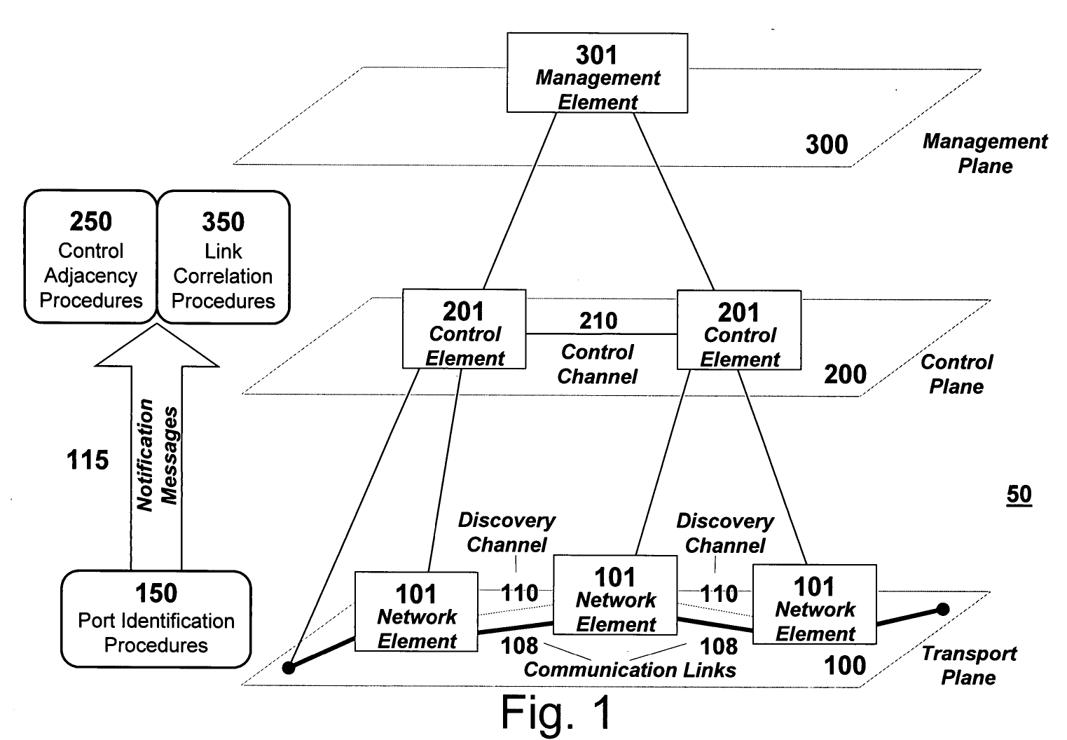

FIG. 1 is a network diagram of a network 50 used to illustrate an embodiment of the present invention. The network may employ, for example, physical transport communication standards such as Digital Signal 1 (DS1), or a Synchronous Optical Network (SONET). Unlike more traditional centralized polling techniques rooted in a management plane operating in or among one or more network elements, the present invention as illustrated in FIG. 1 is rooted in and triggered by network elements 101a, 101b, 101c (collectively referred to as 101) interconnected by communication links 108 composing the transport plane 100. As such, autonomous link discovery of the present invention is event driven and executes in a coordinated, distributed fashion to detect automatically new link connectivity associations and correlate link endpoint attributes between these network elements 101. As an example, a driving event may be the detection by a network element of a new fiber or cable plugged into one that network element's ports. Once a successful link connectivity association with the far end network element has been determined, autonomous notifications of this correlated link connectivity association are sent to management elements 301 and/or control elements 201 residing in their respective management 300 and control 200 planes. The notifications are discussed in further detail below.

Port identification procedures 150 execute entirely within the transport plane 100 and are triggered by the communication of port identities across a transport link's in-band “discovery channel” 110 between network elements connected by that link. The exchange of port identification information between the network elements constitutes a remote port identification event (also referred to herein as a “port event”) to be conveyed via one or more notification messages 115 to either control elements 201a and 201b (collectively 201) residing within the control plane, management element 301 residing within the management plane 300, or both.

Control adjacency procedures 250 are responsible for the establishment of all required communications channels needed in either the control plane 200 and/or management plane 300 so that link correlation procedures 350 can execute.

Link correlation procedures 350 execute in either the control plane 200 or management plane 300 subsequent to the establishment of appropriate control adjacencies. Link correlation procedures 350 correlate and negotiate link related attributes to the point of agreement or denial resulting in either link discovery or various link attribute mismatch events being generated. The successful completion of link correlation procedures 350 means that a valid link has been discovered between the local and remote network elements 101, and notification of this link may now be placed towards the management 300 and control planes 200 for utilization in their respective connection provisioning/switching functions. Link correlation procedures 350 operate and communicate via messages over a control channel 210 as established by control adjacency procedures 250.

Due to the decreased dependencies discussed earlier, the present invention assists in the reduction of inter-layer interfaces and execution sequencing dependencies of management and control actions and events across client/serving transport layers 100. As such, vendor X's management 300 and control planes 200 administering or controlling any given serving transport layer (e.g., the OC-n line layer) may operate fairly independently of vendor Y's management 300 and control planes 200 that administer or control a client transport layer 100 (e.g., the STS path layer). This de-coupling is enabled by allowing the client transport layer 100 to discover needed link resources set up by its serving transport layer 100 whenever that layer completes its control 200 and management plane 300 activities needed to establish and validate the serving link. This also provides customers greater flexibility in terms of network operations and greater freedom to mix and match different vendors, as deemed necessary.

Rather than using a management element to dictate the transport plane's 100 topology from the management plane 300, the present invention facilitates a dialog between the management 300 and transport planes 100 in determining and aligning their respective topological views. With link discovery notifications emanating from the transport plane 100, the management 300 and control planes 200 can make the determination to update their topological viewpoints to reflect these new associations or conduct additional operational actions to bring the transport plane 100 and the management 300/control planes' 200 topology views into alignment. With improved performance and scale, the embodiments of the present invention can be a beneficial tool to be used in the reduction/closure of the topology mismatch window induced by the increased dynamics of transport networks.

Port Identification Procedures

The combination of a local network element's local port identity and a remote network element's remote port identity provides an informational context of a transport link that connects a local network element 101a and remote network element 101b. The local port identity maintained by a network element 101a is communicated across the associated port's discovery channel 110 supported by the communication links 108 for detection by a remote network element 101b connected to that link via its own local port. The discovery channel 110 is a communication channel adapted for use in according to the principles of the present invention to transport messages carried in-band on the link to be discovered in the process described herein. A number of port identification procedures deal with the communication and detection of port identification attributes between network elements across the discovery channel 110 as well as the notifications emanated towards the appropriate control and management plane elements of this information.

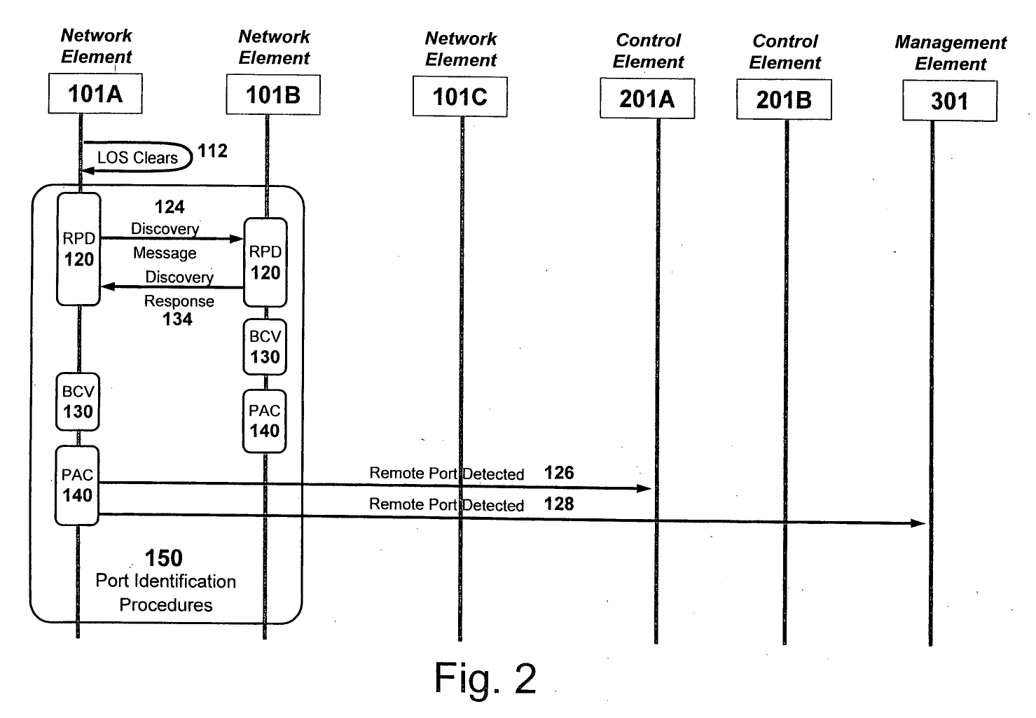

The discovery channel 110 is used by autonomous link discovery procedures to communicate port identities via a “discovery message” 124 and an associated “discovery response” 134 between the endpoints of the link under discovery as shown with reference to FIG. 2. Some possible discovery channel 110 physical layer implementations are as follows:

OC-n Line: section trace overhead

STS-n Path: path trace overhead

Note that these are offered as examples only of possibilities underlying the physical layer of the discovery channel 110 as might be implemented for OC-n Line and STS-n Path links. The underlying physical layer of the discovery channel 110 is based on an in-band mechanism utilizing some portion of the bandwidth of any given link 108 connecting two network elements 101 so as to establish communication continuity across that link 108. With the discovery channel 110 being in-band, the arrival on any given network element of a message emanated by another network element across the discovery channel 110 implies link connectivity between the sending and receiving network elements 101 (e.g., network elements 101a, 101b respectively).

The discovery message 124 and the associated discovery response 134 are used to convey various local and remote port identities between the two ports terminating a link 108. The discovery message 124 contains the “local port” ID of the transmitting network element. The discovery response 134 contains the “local port” ID of the transmitting network element and also “observed remote port” information that is updated at network elements to take the value of “local port” ID information received in discovery messages 124 or discovery responses 134. As such, the transmission of a discovery message 124 and reception of a discovery response 134 acts as the triggering mechanism for a number of functions that keep the current values of various port identification attributes up to date between the two endpoints of a link.

FIG. 2 illustrates the steps to a successful completion of the port identification procedures spanning a series of network elements. After a new fiber or cable 108 is plugged into one of a network element's ports 101a, a Loss of Signal (LOS) clear occurs 112. If a “link discovery enabled” attribute is set, a Remote Port Detection (RPD) procedure 120 triggers to convey the local port 101a's identity (i.e., the “local port” ID attribute value) to the remote port in remote network element 101b as a parameter within the discovery message 124.

If a “link discovery enabled” attribute is set, a Remote Port Detection (RPD) procedure 120 triggers upon the reception of either a discovery message 124 or a discovery response 134 containing a validly formatted “local port” ID parameter. The value of that received “local port” ID becomes the current value of the receiving port's “observed remote port” ID attribute value. The “link discovery enabled” attribute must be set to “enabled” before discovery message transactions are processed further.

A discovery response 134 includes the transmitting network element's “local port” ID, as well as the “observed remote port” ID. Upon receipt of a discovery response 134 containing a validly formatted “observed remote port” ID parameter, a network element updates its own “observed local port” ID based on the received “observed remote port” ID. Note that if prior discovery message(s) 124 have not been received across the local port, then the observed remote port ID attribute value should be set to NULL.

For example, with respect to FIG. 2, local network element 101a sends its local port ID in discovery message 124 to remote network element 101b. Remote network element 101b updates its “observed remote port” information to the value of local network element 101a's “local port” ID. Remote network element 101b sends a discovery response 134 to local network element 101a that provides remote network element 101b's “local port” ID information, and also provides the remote network element's 101b “observed remote port” information. Local network element 101a receives the discovery response 134 with remote network element's 101b “observed remote port” information and uses that value to update local network element's 101a “observed local port” information.

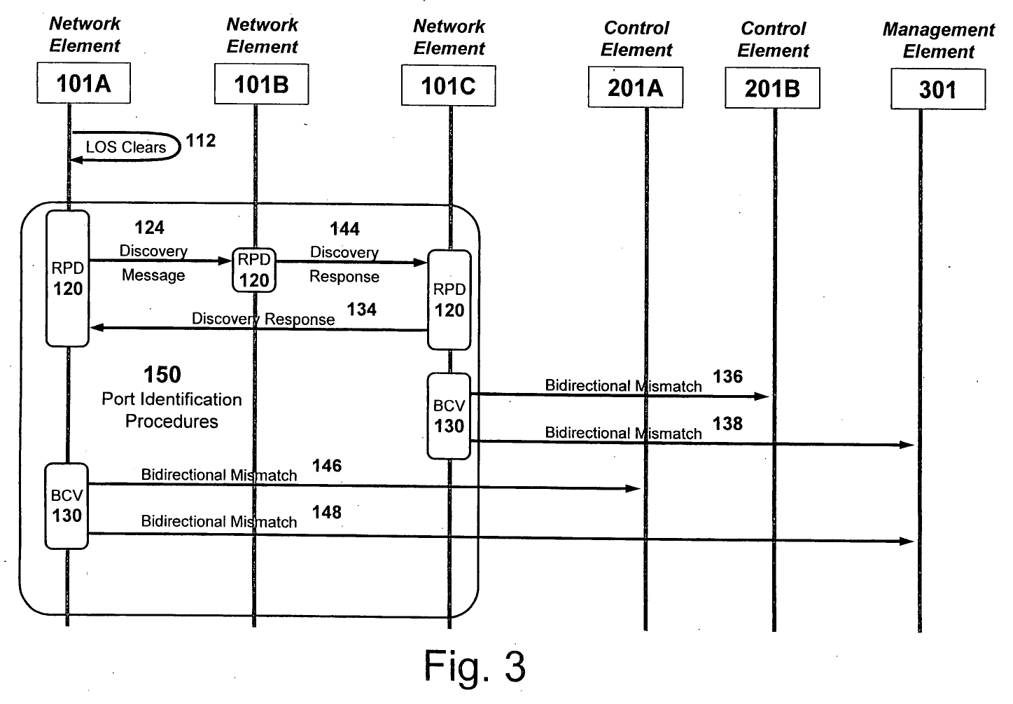

A Bidirectional Connectivity Validation (BCV) procedure 130 verifies that the transmit fibers and receive fibers are physically connected to the same pair of ports. If so, then the values of the local port's “local port” ID and “observed local port” ID attribute values are in agreement. If not, then a “bidirectional mismatch” event is detected as shown in reference to FIG. 3.

FIG. 3 illustrates the case where a BCV procedure 130 identifies a bidirectional connectivity mismatch. If the BCV procedure 130 does not verify that the transmit and receive fibers are physically connected to the same pair of ports, network elements 101a, 101c sends a “bidirectional connectivity mismatch” event 136, 138, 146, 148 to the elements residing in the control 200 and/or management planes 300. The bidirectional mismatch occurs in FIG. 3 because network element 101c (i) has updated its “observed remote port” ID to match the “local port” ID information of network element 101b that it has received in discovery response 134, and (ii) has updated its “observed local port” ID to match the “observed remote port” ID (having the value of the local network element's 101a “local port” ID) sent by network element 101b. Network element 101c identifies a bidirectional connectivity port mismatch when it compares its own “local port” ID value to the updated “observed local port” ID value. Subsequently, local network element 101a receives the “observed remote port” ID sent in discovery response 144 and updates local network element 101a's “observed local port” ID. The mismatch between local element 101a's “local port” ID value and its “observed local port” ID value results in a bidirectional connectivity mismatch. Both the “local port” ID and “observed local port” ID attribute values must contain validly formatted non-NULL values for this BCV procedure 130 to execute successfully.

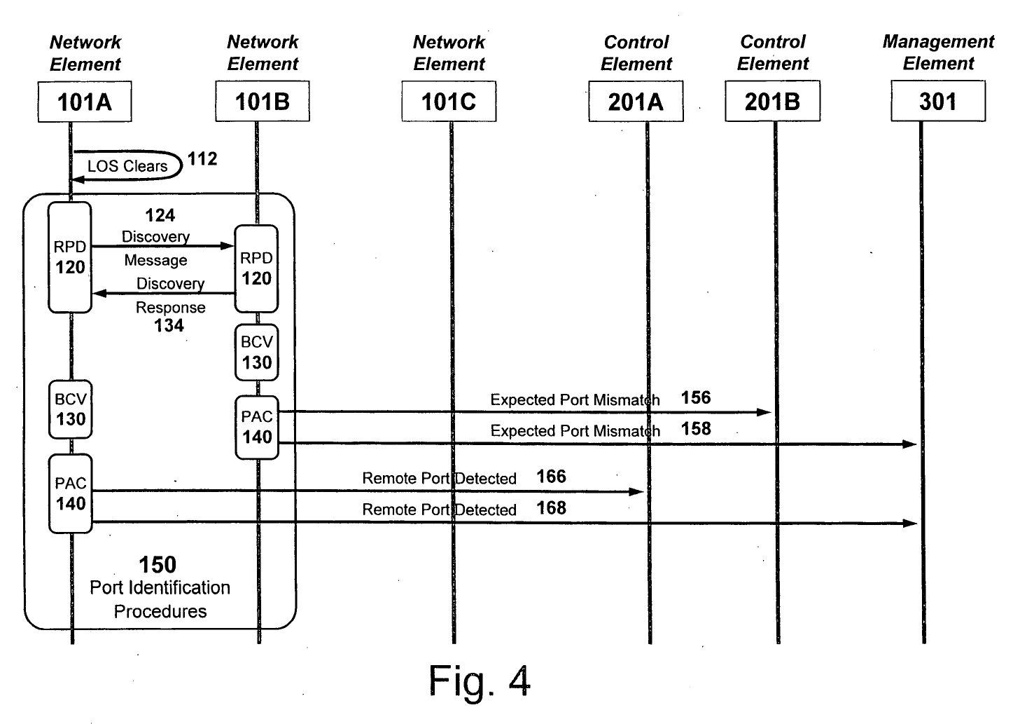

If a bidirectional connectivity mismatch event is not detected by the BCV procedure 130, a Port Attribute Correlation (PAC) procedure 140 verifies that expected (i.e., provisioned) versus observed port attribute values are in agreement. If they are not, then the appropriate mismatch notifications are issued as shown with reference to FIG. 4.

In FIG. 4, a mismatch in the PAC procedure 140 indicates a mismatch problem between expected (i.e. provisioned) versus actual (i.e., as determined via discovery) connectivity as determined during a RPD procedure 120. This condition arises when the value of the “observed remote port ID” attribute value does not agree with the value of the “expectetd remote port ID” in a receiving network element. In FIG. 4, the remote network element 101b updates its “observed remote port ID” information to match the “local port ID” of remote network element 101 a as contained in discovery message 124. If the remote network element 101b has an “expectetd remote port ID” that varies from its updated “observed remote port ID”, a remote port identify mismatch occurs. If a remote port identity mismatch occurs, an “expected port” mismatch event 156, 158 will be sent to the elements residing in the control and/or management planes 200, 300. In addition, a remote port detected event 166, 168 will be sent to the control 200 and/or management planes 300. Both the observed remote port ID and the expected remote port ID attribute values must contain validly formatted non-NULL values for this PAC procedure 140 to execute.

Any given port on a multi-rate port card can terminate and frame to multiple native SONET/SDH line rates (OC-3/STM-1, OC-12/STM-4, OC-48/STM-16, OC-192/STM-64). In order for the remote port identification procedure to function, multirate port cards automatically cycle through the native rates supported by any given port (OC-3, OC-12, OC-48) until framing is achieved.

In some circumstances, it is possible to provision the expected line rate on a per port basis for multi-rate line cards. An expected line rate mismatch standing condition arises when the port's observed line rate and expected line rate attributes do not agree. The detection of this condition results in an expected line rate mismatch event notification being issued to either the control plane 200 and/or management plane 300 destinations as determined by a notification destinations attribute value.

If, as in FIG. 2, the expected port information matches with the observed port information, the appropriate elements within the management and/or control planes are made aware of the newly discovery link via a “remote port detected” event notification 126, 128. This event would trigger the execution of link correlation procedures 350 within the control/management planes 200, 300.

Link Correlation Procedures

After port identification procedures successfully verify that the expected and observed port information are in agreement, link correlation procedures 350 perform the correlation and/or negotiation of link related attributes between the local and remote ports. Link attributes may be determined automatically via detection of new equipment (i.e., the observed link attribute values) or manually via provisioning actions (i.e., the expected link attribute values) of associated attribute values residing in the management, control, or transport planes. The determination of whether the control plane resident or management plane resident attributes are correlated against the transport plane resident attributes is a function of whether the link correlation procedures 350 are executing in the control or management planes. Any mis-comparisons between observed and expected link attribute values may be negotiated between the link endpoints. Non-negotiation of mis-compared or missing link attributes results in appropriate link attribute mismatch conditions being reported via notifications 210 to management elements 301 residing in the management plane 300 for resolution by other means (e.g., management/maintenance actions).

The successful correlation of all link attributes means that the link's related attributes are conducive to each other, and that the newly discovered link is worthy of bearing service. At this point, management elements 301 residing in the management plane 300 and/or control elements 201 residing in the control plane 200 are made aware of the newly discovery link via a “link discovered” event notification.

As an example, in the case of the control plane, the link discovered event notification would be an enabler for the advertisement of the newly discovered link to the routing functions performed via control elements 201.

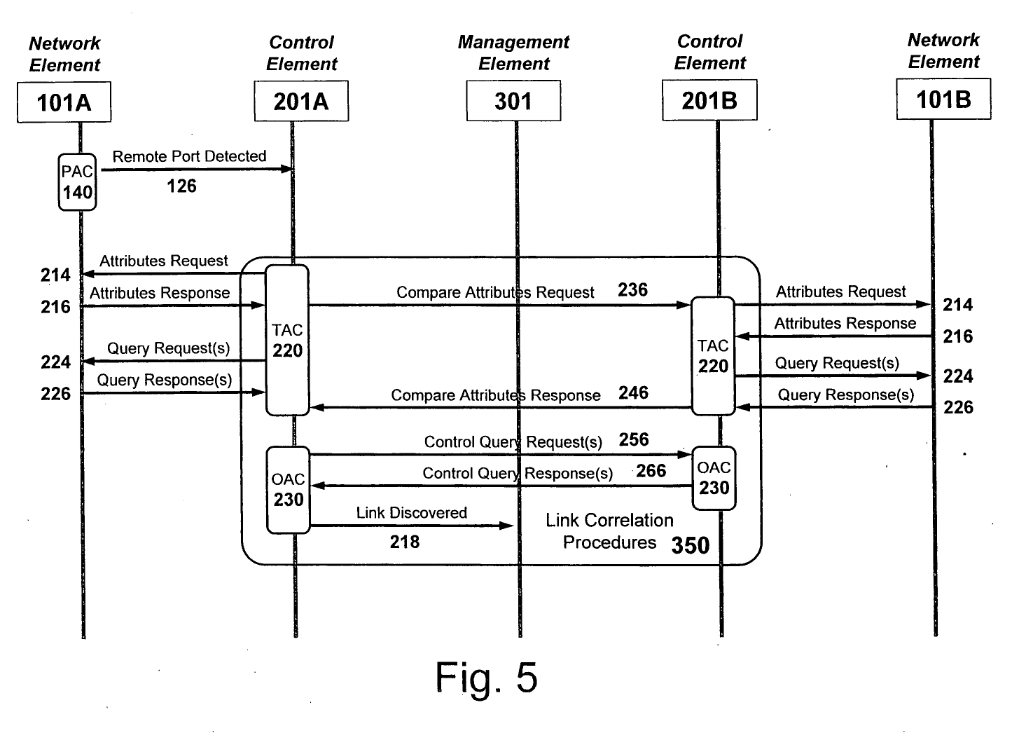

FIG. 5 illustrates an embodiment of the invention where link correlation procedures 350 execute on control elements 201a, 201b residing in the control plane 200. If link correlation procedures 350 are executing in the control plane 200, then the values of control plane resident link attribute values are compared against the similar transport plane resident link attribute values maintained by network elements 101a, 101b. A control plane based implementation of link correlation procedures 350 is distributed between the two control element instances 201a, 201b associated with the network element 101a, 101b on either end of the newly discovered link. This distributed approach is supported via communication across a control channel 210 between the respective control element instances 201a, 201b. Each control element instance 201a, 201b then interacts with its respective network element 101a, 101b to retrieve pertinent link attribute values needed to carry out the link correlation procedures 350.

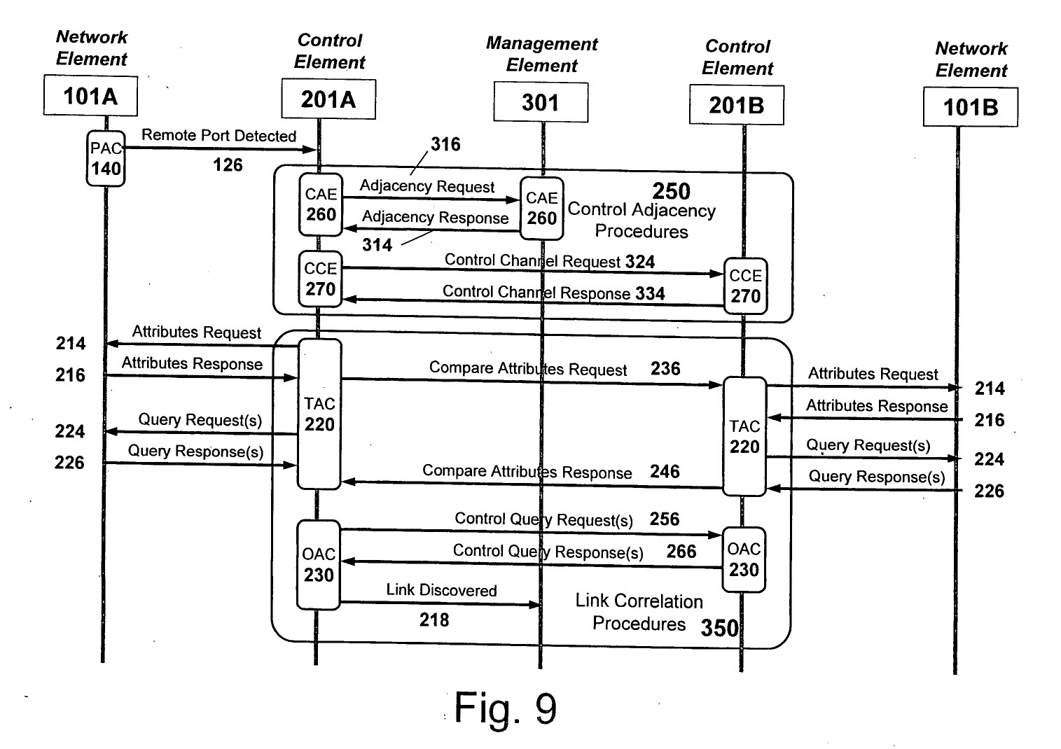

The link correlation procedures 350 are triggered by a “remote port detected” event notification 126 from the PAC procedure 140. If a control channel 210 spanning an established control adjacency does not exist with the remote control element of the “remote port detected” event notification 126, then control adjacency procedures 250 must first be executed to establish such a control adjacency and control channel 210 as discussed-later in the example scenario of FIG. 9. Once a control channel exists subsequent to the running of control adjacency procedures 250, link correlation procedures 350 may run.

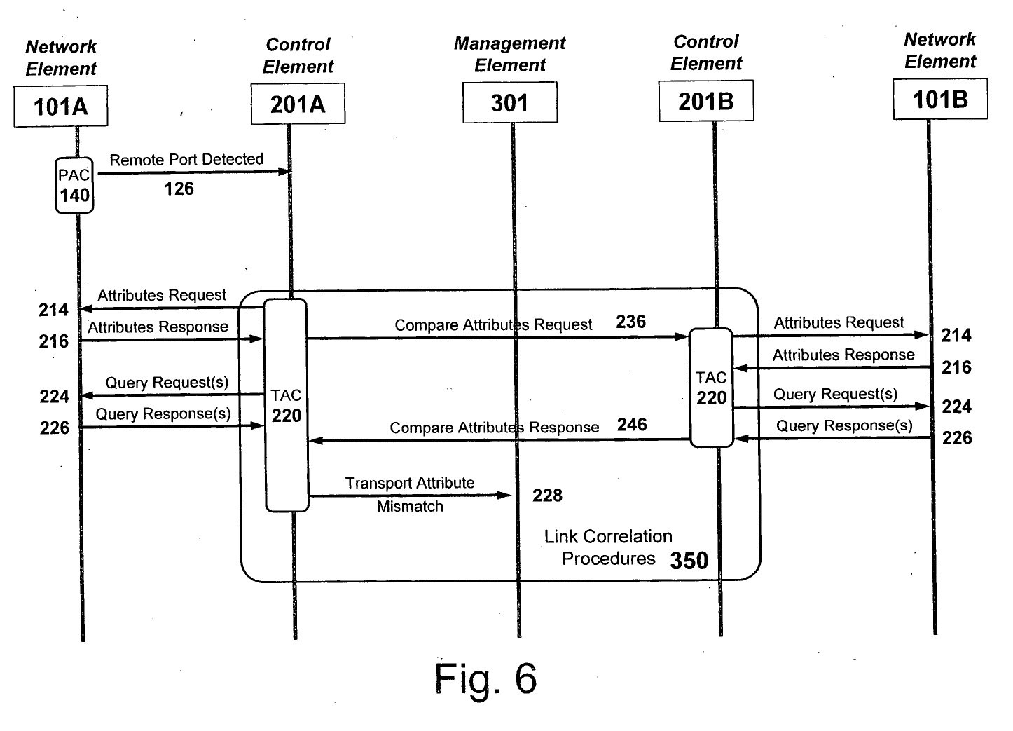

A Transport Attribute Correlation (TAC) procedure 220 verifies that the values of the transport plane-resident attribute values for the local and remote ports are in agreement with each other. Towards this end, the TAC procedure 220 will execute a number of “attribute request” 214—“attributes response” 216 and “query request” 224—“query response” 226 transaction(s) to both network elements 101A, 101B anchoring the endpoints of a newly detected link. Corresponding port attributes retrieved from the two network elements 101A, 101B will then be compared in a “compare attributes request” 236—“compare attributes response” 246 transaction for any potential mismatches. If any mismatches are found, then a “transport attribute mismatch” condition exists and the “transport attribute mismatch” event notification 228 will be transmitted to a management element 301 as shown in FIG. 6.

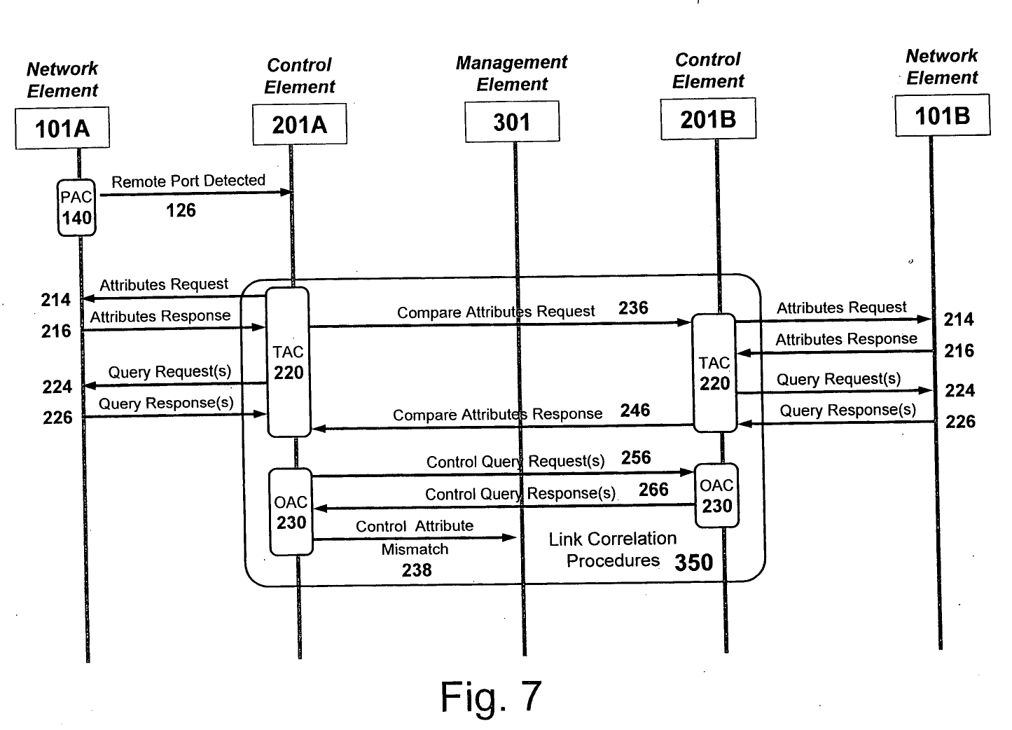

If a “transport attribute mismatch” condition is not detected by the TAC procedure 220, then an Operations Attribute Correlation (OAC) procedure 230 verifies that the values of the transport plane resident local and remote ports attribute value obtained by the previously executed TAC procedures 220 are in agreement with similar local and remote port attribute values residing in the control and/or management plane. The OAC procedure 230 executes a number of “control query request” 256—“control query response” 266 transaction(s) to a peer control element 201. Corresponding port attributes retrieved from the peer control element 201 are then compared for any potential mismatches. In this way, inconsistencies in configuration of expected values of attribute values residing in the control 200/management planes 300 and similar attribute values residing in the transport plane 100 are proactively unearthed prior to a link being placed into service. If any mismatches are found, then a “control attribute mismatch” standing condition exists and the appropriate “control attribute mismatch” event notification 238 will be transmitted to a management element 301 as shown in FIG. 7.

The successful correlation of all link attributes via the link correlation procedures 350 specified above means that the link's related attributes are conducive to each other, and that the newly discovered link is worthy of bearing service. At this point, the appropriate management 301 and/or control 201 element(s), are made aware of the newly discovery link via a “link discovered” event notification 218.

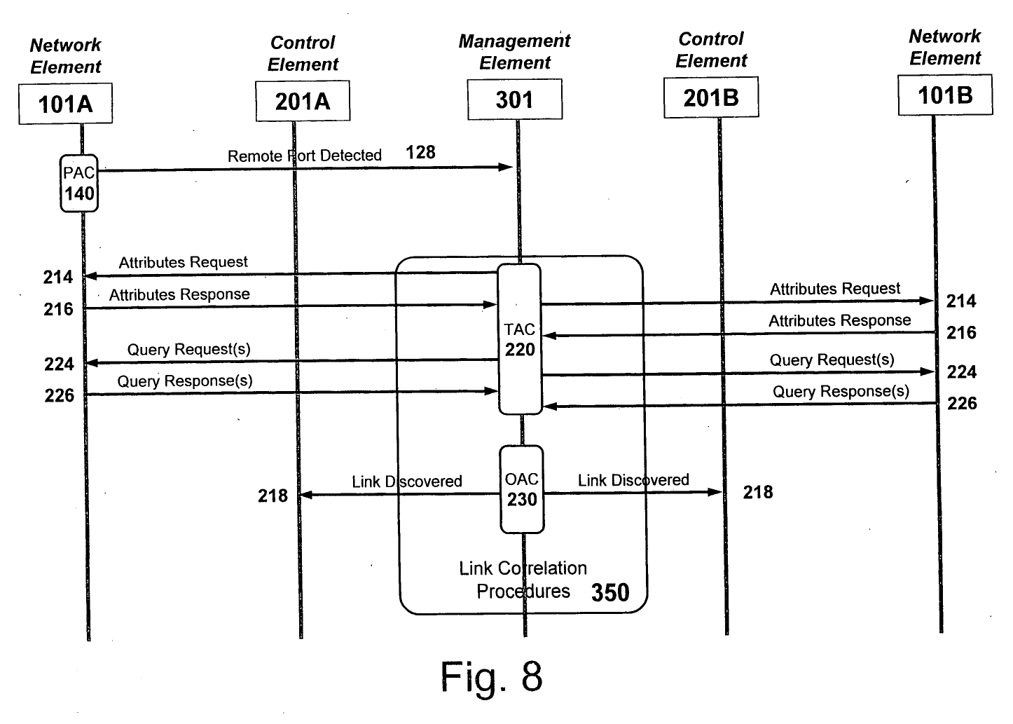

FIG. 8 illustrates an embodiment of the invention where link correlation procedures 350 execute in the management plane 300 as triggered by a “remote port detected” notification 128 emanating from the PAC procedure 140. In this scenario, the values of management plane resident attribute values are compared against the related transport plane resident attribute values. A management plane 300 based implementation of link correlation procedures 350 may be centralized to one or more management elements 301. In this case, the management element 301 interacts directly via existing management protocols with the respective network elements 101a, 101b on either end of the newly discovered link to carry out the link correlation procedures 350.

Control Adjacency Procedures

If a control channel does not already exist between the control elements 201 or management elements 301 associated with the endpoints of a newly discovery link, then a control channel 210 along with any supporting control adjacencies must be established. Control adjacency procedures 250 are responsible for the establishment of all required control adjacencies and the control channels 210 that traverse the control adjacencies. These control channels are needed in either the control and/or management planes so that link correlation procedures 350 can execute.

Link correlation procedures 350 may be allocated for execution on either control elements 201 residing within the control plane 200 or management elements 301 residing within the management plane 300. This implementation choice dictates when control adjacency procedures 250 are invoked.

FIG. 9 illustrates an embodiment of the present invention where control adjacency procedures 250 execute in the control plane 200 to establish a control channel 210. Link correlation procedures 350 executing in the control plane are reliant on communications across a control channel spanning control adjacencies between the two control element elements 201a, 201b that control the endpoints 101a, 101b of a newly discovered link. Upon the reception of an initial “remote port detected” notification 126 emanating from the PAC procedure 140, control adjacency procedures 250 are executed to establish a control channel 210 in the control plane before link correlation procedures 350 can proceed.

A Control Adjacency Establishment (CAE) procedure 260 establishes a control adjacency between the control element(s) 201a, 201b associated with the ports presented via the “remote port detected” 126 notification. Towards this end, the CAE 260 procedure executing in control element 201a executes an “adjacency request” 316—“adjacency response” 314 transaction from CAE procedure 260 executing in management element 301. In one embodiment of the present invention, the information obtained by the “adjacency request” 316—“adjacency response” 314 transaction includes communication addresses (e.g., Internet Protocol addresses) of the specified control elements 201a, 201b associated with the ports presented via the “remote port detected” 126 notification. The combination of these addresses composes the context of the control adjacency between control elements 201a, 201b needed to carry out the subsequent link correlation procedures 350.

With the control adjacency successfully established by CAE procedures 260, Control Channel Establishment (CCE) procedures 270 executing on control elements 201a, 201b utilize a “control channel request” 324—“control channel response” 334 transaction to establish a control channel 210 within the context of the newly established control adjacency between control elements 201a, 201b.

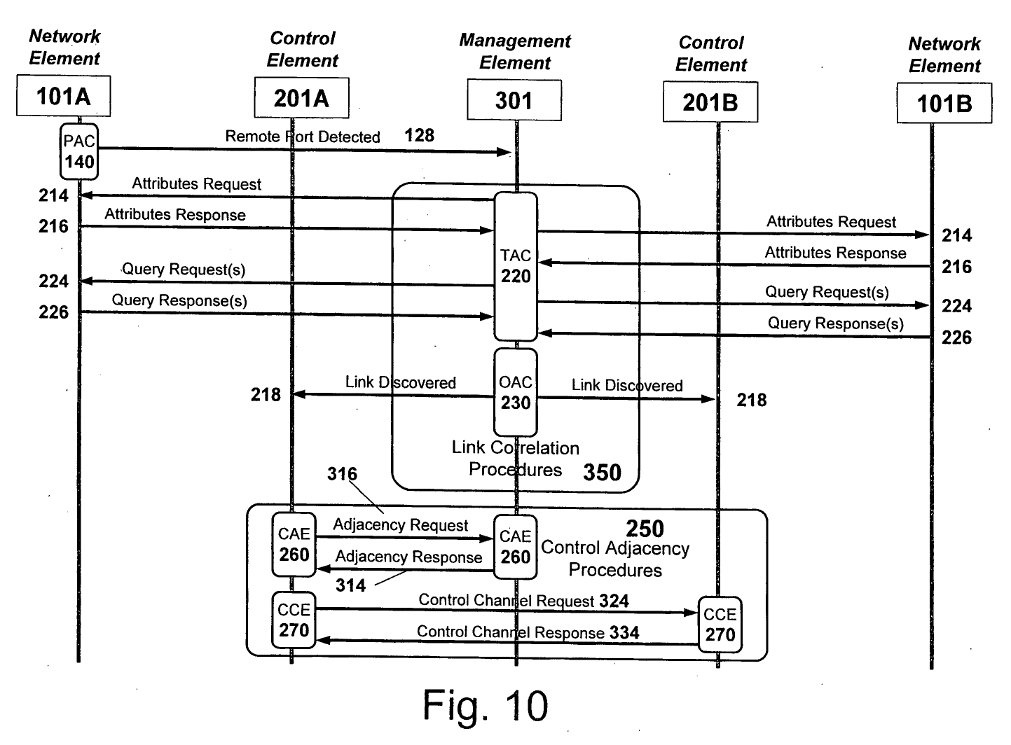

In another embodiment of the present invention shown in FIG. 10, link correlation procedures 350 execute entirely in the management plane 300. In this embodiment of the present invention, the same “adjacency request” 316—“adjacency response” 314 and “control channel request” 324—“control channel response” 334 transactions as depicted in FIG. 6 and FIG. 9 are executed. Note also that the “compare attributes request” 236—“compare attributes response” 246 and the “control query request” 256—“control query response” 266 transactions as depicted in FIG. 6 and FIG. 9 are not needed in the FIG. 10 embodiment of the present invention. This is because the management plane resident link attributes are accessible by access functions local to the management element(s) 301 executing the link correlation procedures 350. As such, in this embodiment of the present invention, there is not a need for a control channel 210 between control elements 201a, 201b.

It may be desirable however, to establish a control channel 210 needed in support of signaling inherent to subsequent functions (i.e., routing, connection control, etc.) performed within the control plane 200. FIG. 10 also illustrates the same control adjacency procedures 250 described by FIG. 9 as triggered by a “link discovered” notification 218 emanating from the OAC procedure 230.

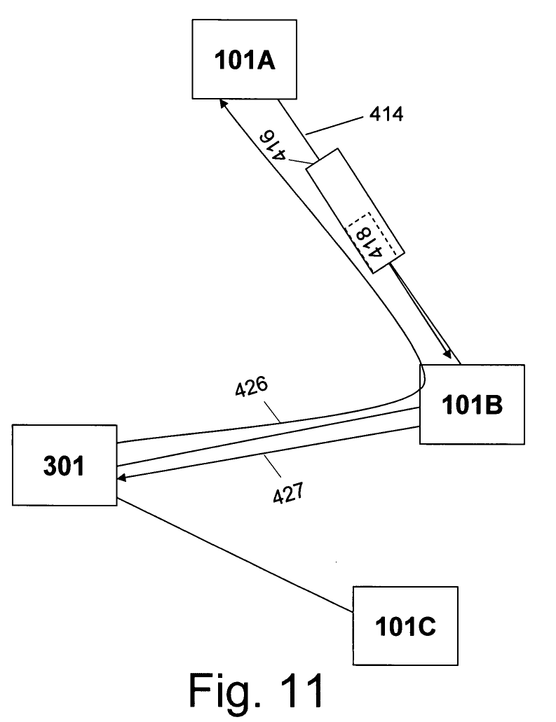

As shown in FIG. 11, another method of establishing network management connectivity in a network can be performed by sending a signal 414 from a network element 101A over a network path, the signal containing an initiation message 416 in an overhead section that indicates a unique identifier 418 of the network element. The unique identifier could be, for example, a Medium Access Controller (MAC) address or an Internet Protocol (IP) address. An intervening network element 101B receives signal 414 and creates notification signal 427 based on the content of 418 to management element 301. In various embodiments of the invention, the notification signal 427 may be signal 414 simply forwarded, it may be an entirely new signal, or it may be a new signal containing the initiation message 416 from signal 414. Management element 301 receives the signal, and processes the initiation message to make a connectivity determination. In an embodiment of the present invention, network element 101B initially processes the initiation message in the overhead section of the signal 416, and forwards notification signal to management element 301. If management element 301 determines that a connection to the initiating network element should be made, it notifies network element 101B to make the data path connection to network element 101A. Next a control channel connection between the management element and the network element is established 426 via network element 101B.

In an electrical signaling network, one type of physical transport standard used to communicate between network elements is Digital Signal 1 (DS1). DS1 (also known as T1) is a North American standard developed by an American National Standards Institute (ANSI) T1 subcommittee. A network link using DS1 has a total bandwidth of approximately 1.544 Mbps and is capable of multiplexing 24 potential channels for voice or data. Another type of physical transport standard is Digital Signal 3 (DS3), which provides a network link with a total bandwidth of approximately 44.7 Mbps and is capable of multiplexing 672 potential channels. In a DS1 network, the initiation message can be placed in a 16 byte portion of a packet overhead. Once a management element 301 processes the initiation message and makes a connectivity determination, management commands can then be sent over payload of the DS1 or be shared with user data. Similar techniques may be employed in an optical network, such as one using a Synchronous Optical Network (SONET) standard.

Those of ordinary skill in the art should recognize that methods involved in the present invention may be embodied in a computer program product that includes a computer usable medium. For example, such a computer usable medium can include a readable memory device, such as a solid state memory device, a hard drive device, a CD-ROM, a DVD-ROM, or a computer diskette, having stored computer-readable program code segments. The computer readable medium can also include a communications or transmission medium, such as a bus or a communications link, either optical, wired, or wireless, carrying program code segments as digital or analog data signals.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of discovering links among network elements in a communications network, the method comprising:
detecting and validating communications ports between network elements via in-band communications initiated by the network elements in the communications network; and
correlating link related attributes of the communications ports over a control channel to automatically discover validated links between the network elements.

2. A method of claim 1 wherein detecting and validating communications ports between network elements identifies a bidirectional connectivity mismatch.

3. A method of claim 1 wherein detecting and validating communications ports between network elements identifies a remote port identity mismatch.

4. A method of claim 1 wherein correlating link related attributes of the communications ports is invoked in a control element in a control plane.

5. A method of claim 1 wherein correlating link related attributes of the communications ports is invoked in a management element in a management plane.

6. A method of claim 1 wherein correlating link related attributes of the communications ports identifies a transport attribute mismatch.

7. A method of claim 1 wherein correlating link related attributes of the communications ports identifies a control attribute mismatch.

8. A method of claim 1 further comprising:
establishing control communications paths.

9. A method of claim 8 wherein establishing a control communication path is invoked in a control element in a control plane.

10. A method of claim 8 wherein establishing a control communication path is invoked by a management element in a management plane.

11. A method of claim 1 further comprising updating a database containing link connectivity information.

12. A computer network system comprising:
a first and second network element in a communications network, each network element having communication ports and each network element capable of:
(i) detecting and validating the communication port connectivity to the other network element via in-band communications initiated by the network elements in the communications network; and
(ii) correlating link related attributes of the communications ports over a control channel to automatically discover validated links between the network elements.

13. A system of claim 12 wherein detecting and validating communications port connectivity between network elements identifies a bidirectional connectivity mismatch.

14. A system of claim 12 wherein detecting and validating communications port connectivity between network elements identifies a remote port identity mismatch

15. A system of claim 12 wherein correlating link related attribute is invoked in a control element in a control plane.

16. A system of claim 12 wherein correlating link related attribute is invoked in a management element in a management plane.

17. A system of claim 12 wherein correlating link related attributes of the communications ports identifies a transport attribute mismatch.

18. A system of claim 12 wherein correlating link related attributes of the communications ports identifies a control attribute mismatch.

19. A system of claim 12 further comprising:
establishing a control communications.

20. A system of claim 19 wherein establishing a control communication path is invoked in a control element in a control plane.

21. A system of claim 19 wherein establishing a control communication path is invoked by a management element in a management plane.

22. A system of claim 12 further comprising a database for storing link connectivity information.

23. A method for establishing management connectivity in a network comprising:
sending a signal from a network element over a network path to a management element, the signal containing an initiation message in an overhead section that indicates a unique identifier of the network element;
processing the initiation message at the management element to make a connectivity determination; and
establishing a connection between the management element and the network element based on the connectivity determination.

24. A method of claim 23 wherein the connection between the management element and the network element is established over a control channel.

25. A method of claim 23 further comprising processing the entire signal at the management element based on the connectivity determination.

26. A method of claim 23 wherein the unique identifier is a Medium Access Controller (MAC) address.

27. A method of claim 23 wherein the unique identifier is an IP address.

28. A method of claim 23 wherein the network is either an electrical signaling network or an optical network.

29. A method of claim 28 wherein the network is a DS1 network.

30. A method of claim 28 wherein the network is a DS3 network.

31. A method of claim 28 wherein the optical network is a Synchronous Optical Network (SONET).

32. A method of claim 23 wherein the signal passes through an intervening network element, the intervening element creating a new signal to send to the management element, the new signal containing an initiation message in an overhead section that indicates a unique identifier of the initial network element.

33. A method of claim 23 wherein the initiation message in the overhead section is the same as in the initial signal.

34. A computer network system comprising:
a network element in a communications network, the element having communication ports, and capable of sending a signal from a network element over a network path, the signal containing an initiation message in an overhead section that indicates a unique identifier of the network element; and
a management element capable of receiving the signal from the network element, processing the initiation message to make a connectivity determination, and establishing a connection between the management element and the network element based on the connectivity determination.

35. A system of claim 34 wherein the connection between the management element and the network element is established over a control channel.

36. A system of claim 34 wherein the management element processes the entire signal at the management element based on the connectivity determination.

37. A system of claim 34 wherein the unique identifier is a Medium Access Controller (MAC) address.

38. A system of claim 34 wherein the unique identifier is an Internet Protocol (IP) address.

39. The system of claim 34 wherein the network is either an electrical signaling network or an optical network.

40. A system of claim 34 wherein the network is a DS1 network.

41. A system of claim 34 wherein the network is a DS3 network.

42. A system of claim 34 wherein the optical network is a Synchronous Optical Network (SONET).

43. A system of claim 34 further comprising an intervening network element, the intervening element receiving the signal and creating a new signal to send to the management element, the new signal containing an initiation message in an overhead section that indicates a unique identifier of the initial network element.

44. A system of claim 43 wherein the initiation message in the overhead section is the same as in the initial signal.
